(19) United States
(12) Patent Application Publication
(10) Pub. No.: US 2026/0254359 A1
(43) Pub. Date: Aug. 27, 2026

(54) ISOLATED POWER CONVERTER

(71) Applicant: Infineon Technologies Austria AG, Villach (AT)

(72) Inventors: Simone FABBRO, Udine (IT); Stefano SAGGINI, Udine (IT); Giulia SEGATTI, Udine (IT)

(21) Appl. No.: 19/391,367

(22) Filed: Nov. 17, 2025

(30) Foreign Application Priority Data
Feb. 24, 2025 (DE) 102025106941.7

(51) Int. Cl. H02M 3/335; H02M 1/00; H02M 3/00

(52) U.S. Cl. CPC H02M 3/33569; H02M 1/0006; H02M 1/0043; H02M 3/01

(57) ABSTRACT

The disclosed concepts relate to an isolated power converter circuit. The circuit includes a transformer including a primary winding and a secondary winding. An intermediate tap of the primary winding is coupled to a source. The circuit further includes a first power amplifier coupled to a first end of the primary winding, a second power amplifier coupled to a second end of the primary winding, a first rectifier coupled to a first end of the secondary winding, and a second rectifier coupled to a second end of the secondary winding. A capacitance provided at the first power amplifier and the second power amplifier, and an inductance provided by the transformer forms a primary resonant tank. A capacitance provided at the first rectifier and the second rectifier, and an inductance provided by the transformer forms a secondary resonant tank.

### CROSS-REFERENCE TO RELATED APPLICATION

This application claims priority to Germany Patent Application No. 102025106941.7 filed on Feb. 24, 2025, the content of which is incorporated by reference herein in its entirety.

### TECHNICAL FIELD

The present disclosure relates to isolated power converter circuits, systems including the isolated power converter circuits, and methods for transferring power across an isolation transformer.

### BACKGROUND

Current integrated solutions for isolated gate drivers encounter the challenge that a large portion of the device area is taken up by an isolation transformer, which is necessary to provide an isolated supply for the supply domain on the secondary side. To reduce both the space and the cost necessary for this component, high-frequency switching topologies that use reduced inductance, e.g., with air-core magnetic structures, are often employed in isolated power conversion.

However, using transformers with an air core (or with cores with similar magnetic permeability) results in a reduced coupling factor, which typically reduces efficiency of power transfer from the primary to the secondary side with commonly used power conversion topologies. Furthermore, operating at frequencies in the tens of MHz range or greater increases driving losses.

Moreover, striving for footprint space saving, lowest bill of materials count, and cost means that isolated converters which can be integrated in standardized IC packages are more attractive. Commercial solutions typically implement step-down or 1:1 conversion, where the input voltage is higher than or equal to the output voltage. Nevertheless, there may be situations where step-up conversion is desired (where the output voltage is higher than the input voltage). In this case, the limited space available, especially in an IC package, may not allow for power conversion with voltage boosting purely through the transformer winding turn ratio, since increasing the number of windings on the secondary side may require a larger area than can be provided.

Accordingly, there exists a need for an improved isolated power converter.

### SUMMARY

According to one aspect, there is provided an isolated power converter circuit.

The circuit includes a transformer including a primary winding and a secondary winding. An intermediate tap of the primary winding is coupled to a source. The circuit further includes a first power amplifier coupled to a first end of the primary winding, a second power amplifier coupled to a second end of the primary winding, a first rectifier coupled to a first end of the secondary winding, and a second rectifier coupled to a second end of the secondary winding. A capacitance provided at the first power amplifier and the second power amplifier, and an inductance provided by the transformer forms a primary resonant tank. A capacitance provided at the first rectifier and the second rectifier, and an inductance provided by the transformer forms a secondary resonant tank.

According to another aspect of the present disclosure, there is provided a system including a first load terminal for connection to a power source, a second load terminal connected to a load, and an isolated power converter circuit as described above. The first load terminal is coupled to the source of the isolated power converter circuit, and the second load terminal is coupled to the first rectifier and the second rectifier of the isolated power converter circuit.

According to yet another aspect of the present disclosure, a method for transferring power from a first side of an isolation transformer to a second side of the isolation transformer is provided.

The method includes providing power to an intermediate tap of a primary winding on the first side of the isolation transformer, generating a first resonance in the primary winding using a first power amplifier coupled to a first end of the primary winding and a second power amplifier coupled to a second end of the primary winding, rectifying a current caused in a secondary winding on the second side of the isolation transformer that is inductively coupled to the primary winding using a first rectifier coupled to a first end of the secondary winding and a second rectifier coupled to a second end of the secondary winding, and providing the rectified current to an output.

Those skilled in the art will recognize additional features and advantages upon reading the following detailed description, and upon viewing the accompanying drawings.

### BRIEF DESCRIPTION OF THE DRAWINGS

The present disclosure is illustrated by way of example, and not by way of limitation, in the figures of the accompanying drawings in which like reference numerals refer to similar or identical elements. The elements of the drawings are not necessarily to scale relative to each other. The features of the various illustrated examples can be combined unless they exclude each other.

FIG. 1 presents a generalized circuit diagram of a conventional isolated power converter according to an implementation;

FIG. 2 presents an implementation of the circuit diagram of FIG. 1 according to a conventional implementation;

FIG. 3 presents a generalized circuit diagram of an isolated power converter according to an implementation;

FIG. 4 presents an implementation of the circuit diagram of FIG. 3 according to another implementation;

FIG. 5 presents an implementation of the circuit diagram of FIG. 3 including a gate driver circuit according to another implementation;

FIG. 6 presents an implementation of the circuit diagram of FIG. 5 including a specific implementation of the gate driver circuit according to a further implementation;

FIG. 7 presents various waveforms as the circuit depicted in FIG. 6 is operated;

FIG. 8 presents a circuit diagram of an isolated power converter including a specific implementation of the power amplifiers according to a further implementation;

FIG. 9 presents a timing diagram related to the circuit of FIG. 8;

FIG. 10 presents a system incorporating an isolated power converter circuits according to an implementation; and

FIG. 11 presents a flow diagram of a method for transferring power from a first side of an isolation transformer to a second side of the isolation transformer according to an implementation.

### DETAILED DESCRIPTION

The disclosed concepts relate to an isolated power converter circuit. The circuit comprises a transformer including a primary winding and a secondary winding. An intermediate tap of the primary winding is coupled to a source. The circuit further comprises a first power amplifier coupled to a first end of the primary winding, a second power amplifier coupled to a second end of the primary winding, a first rectifier coupled to a first end of the secondary winding, and a second rectifier coupled to a second end of the secondary winding. A capacitance provided at the first power amplifier and the second power amplifier, and an inductance provided by the transformer forms a primary resonant tank. A capacitance provided at the first rectifier and the second rectifier, and an inductance provided by the transformer forms a secondary resonant tank.

As the first power amplifier, second power amplifier and transformer (providing a primary leakage inductance and magnetizing inductance) form a primary resonant tank, there is potential to excite a resonant voltage on the primary side of the transformer, resulting in a first voltage boost. That is, if the first power amplifier and second power amplifier are controlled according to an interleaved mode of operation at a switching frequency that is close to the resonant frequency of the primary resonant tank, a voltage peak may be generated by the residual energy stored in the resonant tank on the primary side when each power amplifier is switched off.

In addition, as the first rectifier, second rectifier and transformer (providing a secondary leakage inductance) form a secondary resonant tank, there is potential to excite a resonant voltage on the secondary side of the transformer, resulting in a second voltage boost. In other words, if the first power amplifier and second power amplifier are controlled according to an interleaved mode of operation at a switching frequency that is close to the resonant frequency of the secondary resonant tank, a further voltage peak may be generated on the secondary side.

Of course, if the resonant frequencies of the primary resonant tank and the secondary resonant tank are similar, a voltage boost may be concurrently generated on both sides. These voltage boosts may increase the voltage provided to the output, without requiring an increase in the turns ratio of the transformer (and the resultant increase in space required for such turns). Accordingly, a power converter circuit is provided that may facilitate a voltage boost whilst only requiring a relatively small area.

Furthermore, due to the interleaved operation of the first and second power amplifiers, EM emissions distant from the device (e.g., a few centimeters from the transformer) may be lowered due to the cancellation of the two magnetic fluxes determined at the transformer windings, provided that a planar transformer is built with counter-wound windings. In addition, the provision of the power amplifiers and the rectifiers on opposite ends of the primary and secondary winding respectively, more effectively realizes the voltage boost on the primary side and on the secondary side. Finally, the voltage stress on the rectifier devices of the rectifiers on the secondary side is halved compared to the use of a single full bridge rectifier.

It is worth noting that the proposed power converter circuit operates efficiently even if the coupling of the windings of the transformer is not particularly strong. Indeed, the topology may exploit the leakage inductance of the primary and secondary winding to form the primary and secondary resonant tanks, which in turn may provide a voltage boost to overcome the loss in efficiency due to a poor magnetic coupling. Of course, a poor magnetic coupling is not essential to the power converter circuit. However, if manufacturing restrictions do not allow for a good magnetic coupling (e.g., due to lack of space, ineffective dimensioning, or cost of materials), the proposed power converter aims to mitigate the loss of efficiency.

In specific implementations, the first power amplifier may comprise a first switch connected between the first end of the primary winding and a first reference potential. The second power amplifier may comprise a second switch connected between the second end of the primary winding and a second reference potential. Then, either a primary capacitor may be provided between the first end of the primary winding and the second end of the primary winding, or a first capacitor may be provided between the first end of the primary winding and the first reference potential, and a second capacitor is provided between the second end of the primary winding and the second reference potential.

To be clear, the first reference potential and the second reference potential may be the same potential (e.g., may both be ground or may both be a positive of negative reference potential).

Furthermore, the first rectifier may comprise a first rectifying device connected between the first end of the secondary winding and a third reference potential, and a second rectifying device connected between the first end of the secondary winding and a load. The second rectifier may comprise a third rectifying device connected between the second end of the secondary winding and a fourth reference potential, and a fourth rectifying device connected between the second end of the secondary winding and the load. The third reference potential and the second reference potential may be the same potential (e.g., may both be ground).

The rectifying devices may be passive devices such as diodes or may be active devices such as switches. In any case, the rectifying devices work together to rectify the current on the secondary side such that a direct current may be provided to the output load.

In some implementations, either a secondary capacitor may be provided between the first end of the secondary winding and the second end of the secondary winding, or a third capacitor may be provided between the first end of the secondary winding and the third reference potential and a fourth capacitor may be provided between the second end of the secondary winding and the fourth reference potential.

The above specific implementation of the circuit provides a power converter that may have a small size and relatively straightforward implementation whilst providing several benefits over prior art power converters. Indeed, increase in efficiency, voltage boosting, small size, low cost, and reduced voltage stress may all be realised by this implementation.

In some implementations, the circuit may further comprise a gate drive circuit configured to control the first power amplifier and the second power amplifier in an interleaved mode of operation synchronized to a switching frequency.

More particularly, the switching frequency may be based on a resonant frequency of the primary resonant tank. Additionally, or alternatively, the switching frequency may be based on a resonant frequency of the secondary resonant tank. Thus, the switching frequency may be selected such that at least one of the resonant tanks is excited by the switching, and therefore provides a voltage boost.

The switching frequency may not be exactly equal to either of the resonant frequencies. In fact, the switching frequency may be smaller than or equal to the resonant frequency of the primary resonant tank. In this way, accidentally exciting higher-frequency resonances of the primary resonant tank may be avoided. In other words, a small time delay may be imposed to a self-resonant nature of the system in order to prevent the higher frequency response being excited, ultimately improving circuit efficiency.

In some cases, the resonant frequency of the primary resonant tank and/or the secondary resonant tank may be configured based on the switching frequency. That is, the capacitances provided at or by the power amplifiers and rectifiers, and/or the inductances provided by the transformer may be selected so as to provide a resonant frequency that is at or near a desired switching frequency. Of course, the interrelation between the switching frequency, resonant frequencies of the resonant tank, and the impact this has on the operation of the circuit will be fully appreciated, and the resulting circuit and operation thereof may be adjusted based on desired application.

In further implementations, the gate drive circuit may be configured to detect a voltage peak at the first end of the primary winding, and switch on the second power amplifier responsive to detecting the voltage peak. Similarly, the gate driver may be configured to detect a voltage peak at the second end of the primary winding, and switch on the first power amplifier responsive to detecting the voltage peak.

To be clear, the voltage peak occurs on the first or second side of the primary winding due to resonant response of the primary resonant tank when either the first power amplifier or the second amplifier is switched off. In other words, the voltage peak is a temporary increase in the magnitude of the voltage on the first or second side of the primary winding. Detecting the peak voltage may be accomplished by standard logic.

In addition, the gate driver circuit may be configured to switch off the second power amplifier once a predetermined length of time has elapsed from switching on the second power amplifier. Equally, the gate driver may be configured to switch off the first power amplifier once a predetermined length of time has elapsed from switching on the first power amplifier. The predetermined length of time may be based on (e.g., be inversely related to) the switching frequency. In this interleaved operation, whenever one power switch is turned off, the opposite one is turned on. In some cases, a large amount of the energy necessary for the turn-on may be provided by the resonant voltage peak determined at the high voltage terminal of the first switch.

In essence, this provides a mode of operation that synchronises the switching of the power amplifiers. When a voltage peak appears at the respective end of the primary winding, this indicates that the respective power amplifier has been turned off (as this results in a voltage peak at this end, due to the resonant effect of the primary resonant tank). This information can therefore be used to synchronise the turn-on of the other power amplifier.

Moreover, the gate drive circuit may be configured to switch on the second power amplifier using the voltage at the first end of the primary winding. Equally, the gate drive circuit may be configured to switch on the first power amplifier using the voltage at the second end of the primary winding.

As a result, the peak voltage present at one end of the primary winding may be recycled and used to switch on the power amplifier connected to the opposing end of the primary winding. As a result, driving losses may be reduced. That is, driving loses may be reduced by using self-oscillating drivers which can also recycle power to deliver the turn-on power for the power amplifiers which drive the primary winding.

In some implementations, the first power amplifier may comprise a first switch connected between the first end of the primary winding and a first reference potential, and a first auxiliary switch connected between the first end of the primary winding and the first reference potential. Equally, the second power amplifier may comprise a second switch connected between the second end of the primary winding and a second reference potential, and a second auxiliary switch connected between the second end of the primary winding and the second reference potential.

In other words, the power amplifiers may comprise more than one switch. The first/second switch and the first/second auxiliary switch may be controlled such that they are switched on at different times.

In particular, the gate drive circuit may be configured to detect an end of a voltage peak at the second end of the primary winding, switch on the second auxiliary switch responsive to detecting the end of the voltage peak at the second end of the primary winding, and switch on the second switch responsive to detecting the voltage peak at the first end of the primary winding.

Equally, the gate drive circuit may be configured to detect an end of a voltage peak at the first end of the primary winding, switch on the first auxiliary switch responsive to detecting the end of the voltage peak at the first end of the primary winding, and switch on the first switch responsive to detecting the voltage peak at the second end of the primary winding.

Accordingly, the first auxiliary switch may be turned/switched on responsive to the detection of the end of the voltage peak (e.g., the end of the resonant voltage increase) at the first end of the primary winding. The second auxiliary switch may be turned/switched on responsive to the detection of the end of the voltage peak at the second end of the primary winding. For example, when the voltage peak on an end of the primary winding falls back to 0V, the respective auxiliary switch is switched on. Then, once a voltage peak at the second end of the primary winding is detected, the first switch may be turned on. Similarly, once a voltage peak at the first end of the primary winding is detected, the second switch may be turned on.

Furthermore, the gate drive circuit may be further configured to switch off the second switch and the second auxiliary switch once a predetermined length of time has elapsed from switching on the second switch. In a similar manner, the gate drive circuit may be further configured to switch off the first switch and the first auxiliary switch once a predetermined length of time has elapsed from switching on the first switch. Like above, the predetermined length of time based on the switching frequency. Therefore, the first auxiliary switch is turned on before the first switch, but they are turned off at the same time, and the second auxiliary switch is turned on before the second switch, but they are turned off at the same time. The concurrent turn off of a switch and its auxiliary switch both connected to the respective end of the same transformer winding determines the onset of the voltage peaking at the end of that transformer winding, setting thereby the switching frequency.

As a result, a transferred power may be increased as the auxiliary switch is turned on for a larger part of the switching cycle. This may result in an improved conversion efficiency.

In yet a further implementation, the first power amplifier may also comprise a first boost switch connected between the first end of the primary winding and the first reference potential, and the second power amplifier may also comprise a second boost switch connected between the second end of the primary winding and the second reference potential.

In this case, the gate drive circuit may be further configured to switch on the first boost switch responsive to detecting the voltage peak at the second end of the primary winding, detect an end of the voltage peak at the second end of the primary winding, switch off the first boost switch responsive to detecting the end of the voltage peak at the second end of the primary winding.

Similarly, the gate drive circuit may be further configured to switch on the second boost switch responsive to detecting the voltage peak at the first end of the primary winding, detect an end of the voltage peak at the first end of the primary winding, and switch off the second boost switch responsive to detecting the end of the voltage peak at the first end of the primary winding.

In other words, each of the first and second power amplifier may comprise a third switch. The boost switch may be synchronized to turn on during the occurrence of the voltage peak at the opposite end of the primary winding. Namely, the first boost switch may turn on when the voltage peak on the second side of the primary winding is detected (e.g., when the first switch turns on) and may turn off when the voltage peak on the second side of the primary winding ends. The second boost switch may turn on when the voltage peak on the first side of the primary winding is detected (e.g., when the second switch turns on) and may turn off when the voltage peak on the first side of the primary winding ends.

As a result, it may be assured that the power converter does not synchronize with spurious higher frequencies, whilst an increase in the power transfer and efficiency is delivered.

In some implementations, the first auxiliary switch may be much smaller in size than the first switch and the first boost switch. That is the first auxiliary switch may have a much lower current capability and/or higher on-resistance than the first switch and the first boost switch. Similarly, the second auxiliary switch may be much smaller in size than the second switch and the second boost switch. That is the second auxiliary switch may have a much lower current capability and/or higher on-resistance than the second switch and the second boost switch. This may ensure that higher resonant frequencies of the first resonant tank are not excited by the first auxiliary switch and/or second auxiliary switch being turned on for a larger part of the switching cycle.

In some implementations, the transformer comprises a core including a material configured to provide galvanic isolation between the primary winding and the secondary winding. In some cases, the material has a relative magnetic permeability less than 10.

For example, the transformer may have an air core or a core with a magnetic permeability close to that of air. Such a core may provide a poor magnetic coupling between the primary winding and the secondary winding. However, as described above, the proposed power converter may take advantage of this poor magnetic coupling to provide an inductance for the resonant tank on the primary side and on the secondary side.

Alternatively, the transformer may comprise a core including a magnetic material. For example, the transformer may comprise one or more cores made with materials that provide a magnetic permeability much greater than that of air. This would improve magnetic coupling between the primary and secondary winding.

In some implementations, the circuit may further comprise a tuning inductor provided in series with the secondary winding. In this case, the tuning inductor may form part of the secondary resonant tank.

That is, the tuning inductor may provide some inductance as part of the secondary resonant tank. This may be desirable when the leakage inductance on the secondary side is particularly low (e.g., due to good magnetic coupling between the windings). Alternatively, or additionally, it may be used to tune the resonant frequency of the secondary resonant tank to a desired value.

In some implementations, the number of turns of the primary winding is the same as the number of turns of the secondary winding. That is, the turns ratio of the transformer may be 1:1. Accordingly, no voltage boost is provided by virtue of the turns ratio, but may be provided by the resonances as described above. Of course, if desired, the number of turns of the primary winding may be greater or less than then number of turns of the secondary winding.

According to other aspects in accordance with an implementation, there is provided a system comprising a first load terminal for connection to a power source, a second load terminal for connection to a load, and an isolated power converter circuit according to any of the disclosed implementations. In this case, the first load terminal is coupled to the source of the isolated power converter circuit, and the second load terminal is coupled to the first rectifier and the second rectifier of the isolated power converter circuit. For example, the second load terminal may be connected to the gate of a power switch that requires galvanic isolation from the power source (e.g., for safety).

Turning to some brief explanation, current isolated power converters require large isolation transformers to provide an isolated supply for the supply domain sitting at the secondary side. To reduce both the space and the cost necessary for this component, high-frequency switching topologies that use reduced inductance air-core magnetic structures are often employed in isolated power conversion. These may be employed regularly for gate drive supplies.

However, using air-core transformers results in reduced coupling factor, which usually makes it more difficult to efficiently transfer power from the primary to the secondary side. Furthermore, operating the switches at high frequencies increases driving losses.

Hence, it has been appreciated that there is a need for an isolated power converter that has minimal power losses (to achieve high conversion efficiency), provides a voltage boost (if required), and operates across a transformer-based galvanic isolation barrier, that comprises a small transformer with a near 1:1 winding ratio, with a potentially poor magnetic coupling between the primary and secondary winding.

Therefore, disclosed implementations provide a power conversion topology that may take advantage of non-ideal coupling effects of the isolation transformer to create a resonant converter. This may help to reduce power losses, whilst requiring little space, and non-complex manufacturing methods.

To be clear, depending on the power conversion needs, the dimensions of the isolation transformer may have a minimum required size, since the magnetic flux and energy which can be coupled from the primary winding to the secondary winding of the transformer also scale with the winding area. Therefore, it may be the case that the transformer needs to be too large (to provide a required power conversion) to be integrated easily and cost effectively on a silicon die. Moreover, typically silicon circuit integration processes set boundaries on the maximum available thickness and width of the metal layers on top of the silicon die (which are manufactured as part of the chip die). In turn, this sets a limit on the resistivity of the integrated transformer metal windings, which directly affects the power conversion efficiency.

For these reasons, it is usually more convenient that, to deliver relatively high power for a given integrated circuit (IC) size scale, the isolation transformer is not implemented by silicon die integration, but by other means such as a printed circuit board (PCB) laminate. This PCB laminate is then, in some way, embedded in a standardized IC package. On the PCB laminate, conductive metallization wiring, insulating layers and inter-layer interconnection options are chosen based on the compromises in terms of geometrical dimensions, resistivity, power conversion efficiency and cost. Nevertheless, even compromising in terms of power conversion efficiency, delivered power, and voltage boosting, such PCB laminate solutions are much cheaper than solutions that are fully integrated on a silicon die. The disclosed isolated power converter may be particularly well-realised using such PCB laminate solutions. As will be discussed, realizing the converter using PCB laminate solutions may provide further advantages, particularly if the isolation transformer is coreless, or includes a core with no significant effect on absolute magnetic permeability (e.g., an air core). However, it should still be appreciated that the proposed isolated power converter may still be implemented by other means.

Implementations of the proposed power converter comprise at least some of the following aspects:
(i) An isolation transformer with a primary winding having an intermediate tap connected to an input/load. For example, the input may be connected to a center-tapped input winding;
(ii) Two power amplifiers, each connected to opposite ends of the primary winding of the isolation transformer, that are time-interleaved on the primary side, used for efficiency targeted primary winding resonant power drive and possible voltage boosting. These may be dual operated/differential/time-interleaved class E power amplifier;
(iii) Two rectifiers on the secondary side, each connected to opposite ends of the secondary winding of the isolation transformer, used for efficiency targeted secondary winding voltage resonant rectification and possible voltage boosting. These may be dual operated/time-interleaved class E rectifiers;
(iv) A driving circuit configured to facilitate gate charge recovery for switching the power amplifiers that drive the input windings. This also allows a power conversion adaptation in terms of deliverable output power, output voltage and efficiency;
(v) Power amplifiers that are segmented, such that multiple switches are used with slightly different switching regimes. This may allow the power conversion, and efficiency of the power amplifiers to be further optimized.

A specific aspect of the power converter are the resonant tanks realised on the primary side and the secondary side. In particular, a resonant tank is formed on the primary side by capacitances provided by (or at) the two power amplifiers and an inductance provided by the transformer (e.g., the magnetizing inductance and/or leakage inductance of the primary winding). A further resonant tank is formed on the secondary side by the capacitances provided by (or at) the two rectifiers and an inductance provided by the transformer (e.g., the magnetizing inductance and/or leakage inductance of the secondary winding). These resonant tanks may be exploited to implement input to output voltage boosting and to improve conversion efficiency.

On the primary side, in one implementation, by using two Class E power amplifiers controlled according to an interleaved mode of operation a quasi-self-oscillating topology is implemented. In the power amplifiers, switch gate charge recycling may be applied, so that driving losses can be minimized. Additionally, a resonance is triggered between the magnetizing inductance of the transformer and the parasitic capacitance of the switch or switches of each power amplifier. This can provide an initial voltage boost at the primary side.

On the secondary side, in one implementation, using two Class E rectifiers, the resonance between the leakage inductance on the secondary side (e.g., due to imperfect coupling between the primary and secondary transformer windings) and capacitance provided at or by the rectifying components may be exploited. This can result in an additional voltage boost, effectively achieving step-up conversion, when necessary.

It is worth noting that this mechanism may exploit what is normally considered to be a weakness of transformers which provide low coupling between input and output windings. Air-core transformers, or transformer which do not rely on isolation materials which provide a significant increase of magnetic permeability compared to that of air, are typically used to reduce both the space and the cost necessary for this component, which may be operated at high-frequency. However, using such transformers results in a reduced coupling factor, which typically reduces efficiency of power transfer from the primary to the secondary side with commonly used power conversion topologies. That is, air coupled transformers may have a relatively large non-coupled, or lost, magnetic flux between transformer windings. This magnetic flux loss can be modeled through an added inductance (e.g., a leakage inductance), which is proportional to the magnitude of the lost magnetic field, in series to the transformer secondary windings. This inductance (alongside the capacitance provided on the secondary side by or at the rectifiers), can be used to establish a further resonance. Hence, a second voltage boost may be obtained via a mechanism that is usually considered a disadvantage (that is, via the lost magnetic flux).

Nevertheless, it should be appreciated that a core providing low coupling is not a necessary part of the power converter. The power converter, including a transformer with good magnetic coupling (e.g., having magnetic cores, etc.) may be beneficial depending on circuit parameter choices and product needs. The inductance on the secondary side may be increased by use of a further inductance connected in series with the secondary winding, if required. It should also be noted that poor magnetic coupling may also arise from other parameters of the transformer, such as its shape, size and relative positioning of primary and secondary windings.

Moreover, the use of two rectifiers allows elements of each single rectifier (e.g., silicon or Schottky diodes) to withstand only half the voltage stress that a single rectifier would, since the voltage stress can be split and shared by the rectifiers connected to the first and second end of the secondary winding. Whilst this results in an added voltage drop across the rectifiers, this is usually negligible compared to the rectified output voltage.

It is also worth reiterating that voltage boosting can be achieved, if necessary, whilst a turn ratio of 1:1 between the primary and secondary winding is maintained. Indeed, depending on the parameters which determine the primary side resonant conversion and the secondary side resonant rectification, conversion factors equal or higher/lower than 1:1 may be obtained without requiring a variation of the winding ratio.

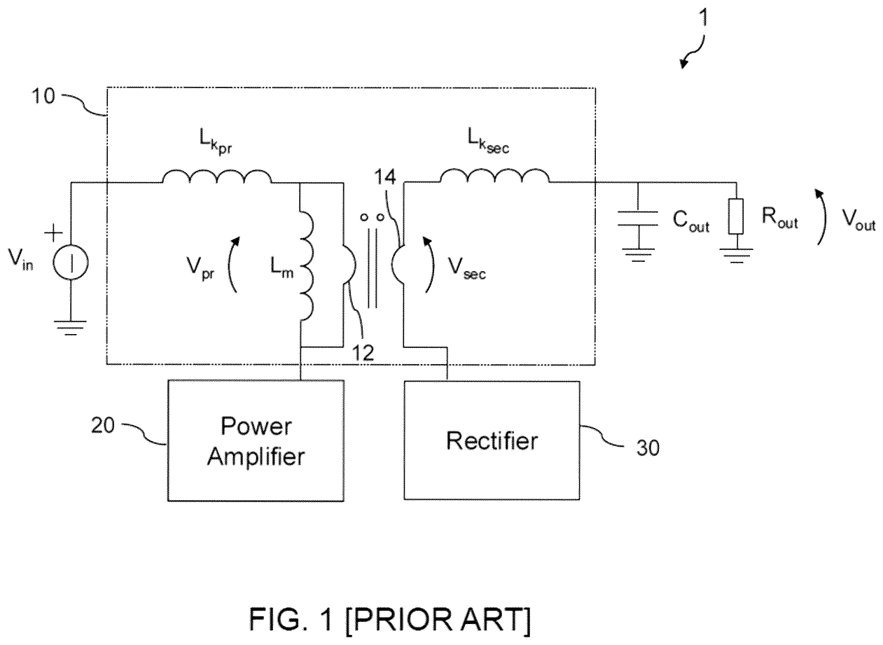

FIG. 1 illustrates a conventional power converter 1. The power converter 1 comprises a transformer 10, a power amplifier 20, and a rectifier 30.

The transformer 10 forms a galvanic isolation barrier between the primary side and the secondary side, and thus the connected power source and load. The transformer 10 is represented in terms of its equivalent circuit. That is, the primary winding 12 is depicted in parallel to a magnetizing inductance, Lₘ, and in series with a primary side leakage inductance, L_{k,pr}. The secondary winding 14 is depicted in series with a secondary side leakage inductance, L_{k,sec}. A first end of the primary winding 12 is connected to the power source, and a second end of the primary winding 12 is connected to the power amplifier 20. A first end of the secondary winding 14 is connected to the load, and a second end of the secondary winding 14 is connected to the rectifier 30. The transformer 10 reflects the voltage on the primary winding 12 to the secondary winding 14. A magnitude of the voltage on the secondary winding 14 may depend on the ratio of turns between the primary winding 12 and the secondary winding 14, amongst other factors. For example, this ratio may be 1:1.

The power amplifier 20 is configured to increase the magnitude of the voltage on the primary side of the transformer 10. To this end, the power amplifier 20 may comprise one or more switching elements. For example, the power amplifier 20 may be a class-E power amplifier to provide high efficiency RF power amplification by optimizing the switching transitions (ZVS), and by reducing power losses. A class-E power amplifier comprises switches operated at radio frequencies and under zero-current or zero-voltage switching schemes. Any known power amplifier may be used in the circuit, given it provides a capacitance, or a capacitor is provided alongside the power amplifier 20.

The rectifier 30 is configured to convert the alternating current on the secondary winding 14 to a direct current. The rectifier 30 may be implemented with passive elements, with active elements, or a combination thereof. The rectifier 30 may be a class-E rectifier to ensure efficient AC-DC conversion with minimal switching noise and reduced peak currents, with corresponding RMS power dissipation reduction. Any known rectifier may be used in the circuit, given it provides a capacitance, or a capacitor is provided alongside the rectifier 30.

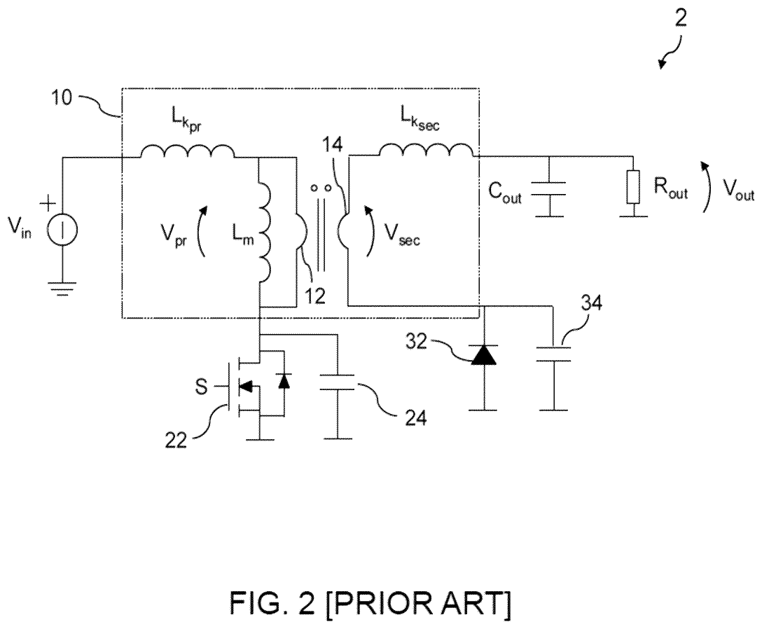

An implementation of the circuit of FIG. 1 is shown in FIG. 2. Specifically, a particular power amplifier 20 and rectifier 30 are provided. The power amplifier comprises a switch 22 and a capacitor 24 connected in parallel between the second end of the primary winding 12 and a reference potential (e.g., ground). The rectifier comprises a rectifying device 32 (e.g., a diode) and a capacitor 34 connected between the second end of the secondary winding 14 and a reference potential (e.g., ground), with the rectifying device 32 blocking current flowing from the second end of the secondary winding 14 and the reference potential.

Combining these power converter and rectifier topologies results in a voltage-boosting architecture that maximizes efficiency, reduces power losses, and minimizes the number of turns required on the secondary winding 14.

The circuit of FIG. 2 operates in the following way:
(i) The gate of the switch 22 turns on, and the inductors, L_{k,pr} and Lₘ, start to charge;
(ii) The gate of switch 22 turns off. The current flows into capacitor 24 upon release of the switch and a resonance begins between the inductors L_{k,pr} and Lₘ and the capacitor 24 in which the inductors, L_{k,pr} and Lₘ, discharge into the capacitor 24;
(iii) The voltage is reflected to the secondary winding 14, and the AC voltage triggers a resonance between inductor, L_{k,sec}, and capacitor 34; and
(iv) The rectifying device 32 rectifies the resulting current.

Accordingly, instead of a simple voltage source at the rectifier input, a resonant system is established through the resonance between the total inductance present at the secondary winding 14 (thus exploiting the leakage inductance of the transformer 10, as a result of the non-coupled magnetic flux) and a capacitance provided at or by the rectifier. In other words, a resonant tank is formed on the primary side by the leakage inductance and the capacitor 24. This secondary side resonant operation results in a further voltage boost, added to that obtained by the resonant mode on the primary side. To be clear, the further voltage boost across the isolation transformer 10 doesn't require an increase in the transformer 10 winding turn ratio, but rather exploits the resonance created on the secondary side.

Hence, the system operates in a multi-resonant mode, characterized by two distinct resonant tanks, on the primary and secondary side respectively, that are crucial for achieving the voltage boost. In fact, the primary side may naturally operate in a quasi-self-resonant mode, enabling zero voltage switching on the primary side, due to the resonance created by the inductance and capacitance on the primary side.

The quasi-self-resonant mode works as follows. By adjusting the on-time of the switch 22, and by prolonging that on-time beyond the half-period of the natural oscillation of the primary side resonant tank (formed by the magnetizing inductance of the transformer 10 and leakage inductance of the primary winding 12, and the capacitor 22) it is possible to increase the voltage peaking at the resonant capacitor when the switch is turned off, and thus to increase of the amplitude of the voltage harmonic component transmitted to the secondary side. The switching period of the primary side depends in this case on the on-time, which becomes longer than that established by the natural resonance period of the primary resonant tank.

If this modified switching frequency is configured to coincide with the resonant frequency of the secondary resonant tank (formed by the leakage inductance on of the secondary winding 14, and the capacitor) a further boost can be obtained. However, this boost in voltage may not necessarily result in an increase in efficiency. Depending on the goals, different compromises between delivered output voltage, converted output power or power conversion efficiency can be found, which may also depend on the time delay added to the natural oscillation period.

Adding a time delay to the natural resonance switching period for determining a prolonged on-time for the primary winding 12 power switch 22 introduces a further advantage. In fact, the resonant frequency of a system which uses a transformer as a part of the resonant tank, may not be uniquely determined by the reactive components only connected to the primary winding 12. A second, higher frequency, resonance peak may appear (or a resonance peak split may occur), depending also on the equivalent impedance appearing to be connected to the secondary winding 14. This secondary impedance may also vary depending on the operating conditions on the secondary side. This higher frequency resonant operation would be detrimental for the conversion efficiency and power delivery and should be avoided. With no countermeasure, and depending on the operating conditions, the converter may start to randomly jump between the two split resonance frequencies, introducing thereby even an unpredictable converter behavior. Introducing a suitable time delay added to the higher (lower frequency) resonance period prevents the higher frequency resonance being excited, since the system then necessarily works always with a frequency which is lower than the lower split resonance. In this sense, this control scheme is a quasi-resonant one, in that the longer period, lower frequency, natural resonance is not perfectly met, but a slightly lower switching frequency is forced by the added time delay, without noticeable power or efficiency losses. In fact, depending on the adaptation of the added time delay, the efficiency may be even improved.

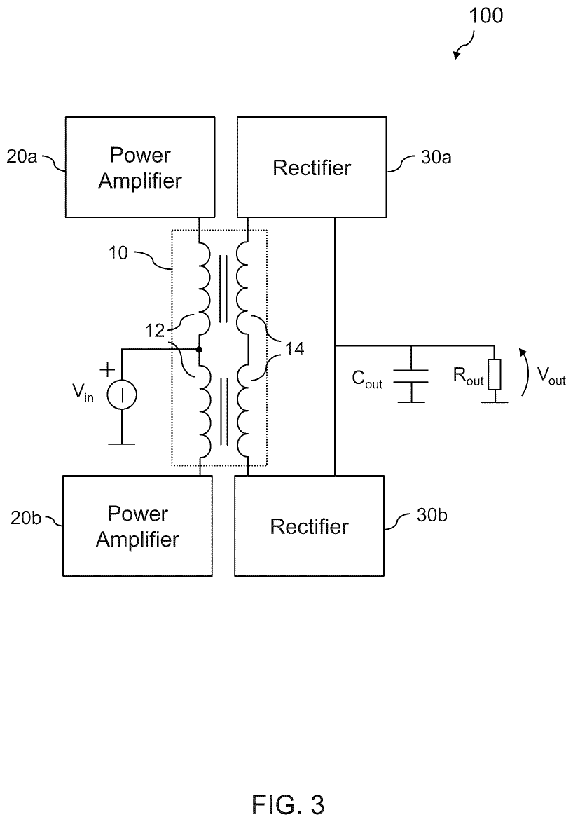

FIG. 3 presents a generalized circuit diagram of an isolated power converter 100 according to an implementation. The circuit of FIG. 3 is similar to the circuit of FIG. 1. However, the circuit further comprises a second power amplifier 20b and a second rectifier 30b, and the input is connected to an intermediate tap of the primary winding 12 of the transformer 10.

In particular, the circuit comprises a first power amplifier 20a connected to a first end of the primary winding 12 of the transformer 10, a second power amplifier 20b connected to a second end of the primary winding 12 of the transformer 10. The first end is opposite the second end of the primary winding 12. The circuit also comprises a first rectifier 30a connected to a first end of the secondary winding 14 of the transformer 10, a second rectifier 30b connected to a second end of the secondary winding 14 of the transformer 10, with each rectifier connected to an output node. The input node is connected to an intermediate tap of the primary winding 12. For example, the input node may be connected to a center tap of the primary winding 12.

A capacitance provided at or by the first power amplifier 20a, a capacitance provided at or by the second power amplifier 20b, and an inductance provided by the primary winding 12 of the transformer 10 forms a first resonant tank. That is, a first resonant tank is provided on the primary side of the circuit by the transformer 10 and power amplifiers. Similarly, a capacitance provided at or by the first rectifier 30a, a capacitance provided at or by the second rectifier 30b, and an inductance provided by the secondary winding 14 of the transformer 10 forms a second resonant tank. In other words, a second resonant tank is provided on the secondary side of the circuit by the transformer 10 and power rectifiers.

By way of explanation, here the operation principle is the same as described in reference to FIG. 1 and FIG. 2. However, as shown, the architecture is duplicated. The power amplifiers may therefore be driven with a 180° phase shift. That is, the first and second power amplifier 20a and 20b may be controlled according to an interleaved mode of operation, where when one power amplifier is turned on, the other is turned off.

This may be performed at a predetermined switching frequency. In some implementations, this predetermined switching frequency may be slightly lower than the resonant frequency of the first resonant tank. As described above, this will lead to a voltage boost on the primary side and will also avoid exciting the potential second (higher) frequency resonant frequency of the resonant tank. Furthermore, the predetermined switching frequency may additionally or alternatively be substantially equal to the resonant frequency of the second resonant tank. As described above, this may lead to a voltage boost on the secondary side. Of course, the first resonant tank and the second resonant tank may be tuned to have resonant frequencies based on a desired switching frequency (e.g., by altering capacitance provided by the power amplifiers and rectifiers, and/or by altering the inductance provided by the transformer 10).

That is, the sum of the voltage at the secondary winding 14 excites the second resonant tank, consisting of the leakage inductance of the transformer 10, and the capacitances provided at or by the rectifiers (e.g., parasitic capacitances in parallel to diodes of a rectifier). Thanks to the natural resonance of the secondary tank, an additional voltage boost may be obtained, without relying on a transformer 10 turn ratio, which would require more build area/volume due to the clearance needed between traces for PCB fabrication.

It is also worth noting that the interleaved operation on the primary side allows the introduction of a further improvement in terms of achievable conversion efficiency. As stated above, whilst the first power amplifier 20a is on, the second power amplifier 20b is off. The voltage at the second end of the primary winding 12 may therefore peak due to the quasi-resonant operation described above when this switching occurs.

This gives the possibility of using that powerful voltage peaking to synchronize the turn on of the first power amplifier 20a with the turn off of the second power amplifier 20b, and to recycle part of the voltage peak energy also to energize the turn on of the first power amplifier 20a. This solution would thereby increase the architecture efficiency. When the second power amplifier 20b is turned off, a voltage peak starts at the second end of the primary winding 12 because of the cut off inductive current. The peaking onset can be detected and used to synchronously determine the interleaved turn on of the first power amplifier 20a. Of course, when the voltage peaking at the second end of the primary winding 12 decreases, the first power amplifier 20a can't lose its power supply (which would result in an undesirable turn off). For this reason, a diode (or another kind of controlled switch) is used to prevent this. While the voltage at the second end of the primary winding 12 is low, a main power supply may ensure that the first power amplifier 20a remains switched on, until a programmable switch off command is received. Of course, additionally or alternatively, similar driving of the second power amplifier 20b using a voltage on the first end of the primary winding may be achieved.

This circuit offers several advantages over the conventional converter. Firstly, driving losses may be reduced by using self-oscillating drivers which can also recycle power to deliver the turn-on power for the power amplifiers which drive the primary winding 12. Secondly, due to the interleaved operation, “far” EM emissions are lowered due to the cancellation of the two magnetic fluxes, assuming that the transformer 10 windings are counter wound. “Far” means that the EM emissions are measured at a distance that is much larger than the transformer 10 winding dimensions (e.g., a few centimeters from the transformer 10). In addition, the dual setup of the power amplifiers and the rectifiers more effectively realizes the voltage boost on the primary side and on the secondary side. Finally, the voltage stress on the rectifier devices of the rectifiers on the secondary side is halved and thus is reduced compared to the prior art.

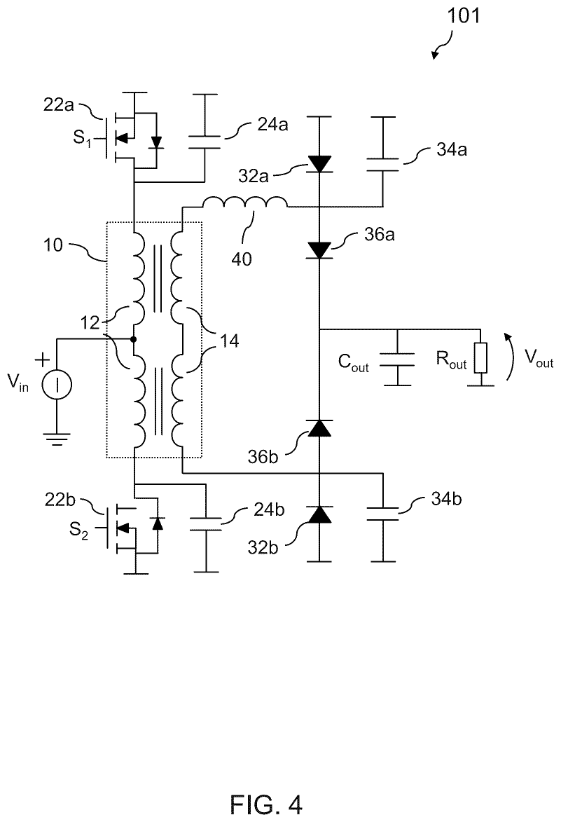

FIG. 4 presents an implementation of the circuit of FIG. 3.

As shown, the first power amplifier 20a comprises a first switch 22a connected between the first end of the primary winding 12 and a first reference potential. The second power amplifier 20b comprises a second switch 22b connected between the second end of the primary winding 12 and a second reference potential.

A first capacitor 24a is provided between the first end of the primary winding 12 and the first reference potential, and a second capacitor 24b is provided between the second end of the primary winding 12 and the second reference potential. Nevertheless, it may equally be the case that the first 24a and second capacitor 24b are replaced by a primary capacitor provided between the first end of the primary winding 12 and the second end of the primary winding 12. In addition, the first reference potential and the second reference potential may be the same potential or may be different potentials.

Further, as shown, the first rectifier 30a comprises a first rectifying device 32a connected between the first end of the secondary winding 14 and a third reference potential, and a second rectifying device 36a connected between the first end of the secondary winding 14 and a load. The second rectifier 30b comprises a third rectifying device 32b connected between the second end of the secondary winding 14 and a fourth reference potential, and a fourth rectifying device 36b connected between the second end of the secondary winding 14 and the load. The rectifying devices shown are diodes, but each may be replaced by a switch or other rectifying device.

A third capacitor 34a is provided between the first end of the secondary winding 14 and the third reference potential, and a fourth capacitor 34b is provided between the second end of the secondary winding 14 and the fourth reference potential. Nevertheless, it may equally be the case that the third capacitor 34a and fourth capacitor 34b are replaced by a secondary capacitor provided between the first end of the secondary winding 14 and the second end of the secondary winding 14. In addition, the third reference potential and the fourth reference potential may be the same potential or may be different potentials. In some implementations, the first to fourth reference potentials may all be ground potentials, and in particular a same ground potential.

Additionally, the circuit may optionally further comprise a tuning inductor 40 provided in series with the secondary winding 14. Although shown connected to the first side of the secondary winding 14, the tuning inductor 40 may equally be provided connected to the second side of the secondary winding 14. The tuning inductor 40 forms part of the secondary resonant tank. The tuning inductor 40 may be used when it is desired to change the resonant frequency of the second resonant tank. This may be beneficial, for example, when the leakage inductance of the secondary winding 14 is very low.

In this case, the on and off switching of the first power amplifier 20a comprises switching on and off the first switch 22a and the on and off switching of the second power amplifier 20b comprises switching on and off the second switch 22b.

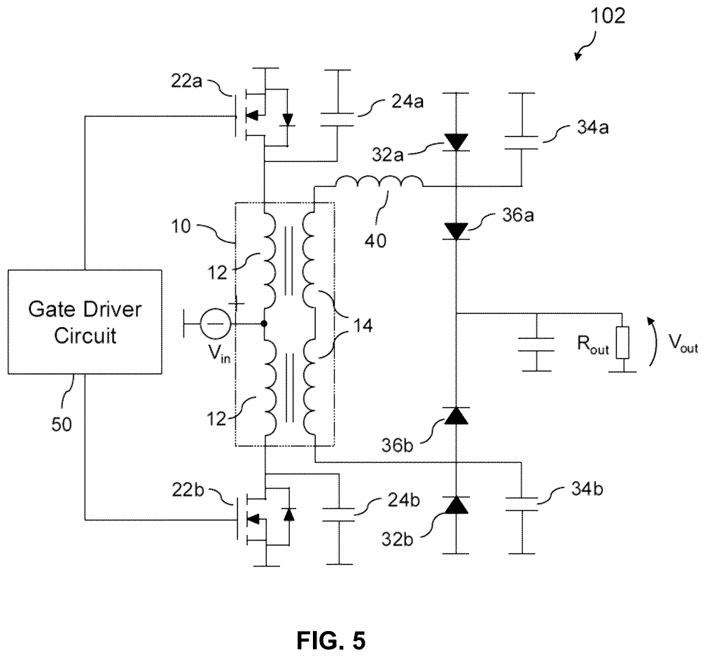

As shown in FIG. 5, this control of the switches may be performed by a gate drive circuit 50 that is configured to drive the switches of the power amplifiers in an interleaved mode of operation.

The gate drive circuit 50 is configured to control the first power amplifier 20a and the second power amplifier 20b in an interleaved mode of operation synchronized to a switching frequency. That is, the gate driver circuit 50 turns the first switch 22a on when the second switch 22b is turned off, and the turns the second switch 22b on when the first switch 22a is turned off. This is performed based on a switching frequency.

The switching frequency to which the interleaved mode of operation is synchronized may be based on a resonant frequency of the primary resonant tank. In this way, there may be a resonance excited on the primary side of the circuit, resulting in a voltage boost. More specifically, the switching frequency may be (only slightly) smaller than the resonant frequency of the primary resonant tank. This may avoid exciting other, higher frequency, resonant peaks of the primary resonant tank.

Further, in this case, the resonant frequency of the secondary resonant tank may be configured based on the switching frequency. That is, the capacitance provided by the rectifiers, and/or the inductance provided by the transformer 10 (and the inductance provide by the optionally tuning inductor) may be selected such that the resonant frequency of the secondary resonant tank is similar to the switching frequency. This may induce another voltage boost on the secondary side by exciting the secondary resonant tank.

Alternatively, in some cases, the switching frequency to which the interleaved mode of operation is synchronized may be based on the resonant frequency of the secondary resonant tank. In this way, there may be a resonance excited on the secondary side of the circuit, resulting in a voltage boost—but there may not be a resonance excited on the primary side if the resonant frequency of the primary resonant tank is different to the switching frequency. Of course, it will be appreciated that there is an inter-dependence on the resonant frequencies of the resonant tanks and the switching frequency—each of which may be adapted and configured based on the particular application of the circuit.

In some implementations, the resonant peak voltages present at the first end of the primary winding 12 and the second end of the primary winding 12 (due to resonance when the first switch 22a and the second switch 22b turn off, respectively) may be used to synchronise turn on of the opposing switch, and potentially to help drive the turn on.

To this end, the gate drive circuit 50 may be configured to detect a voltage peak at the first end of the primary winding 12. Then, when the voltage peak is detected, the gate drive circuit 50 may switch on the second power amplifier 20b (e.g., switch on the second switch 22b). Additionally, or alternatively, the gate drive circuit 50 may be configured to detect a voltage peak at the second end of the primary winding 12. Then, when the voltage peak is detected, the gate drive circuit 50 may switch on the first power amplifier 20a (e.g., switch on the first switch 22a).

To be clear, the voltage peak may be detected by the gate driver circuit 50 using known logic. Of course, the addition of any logic components into the signal path will introduce a delay, and therefore in practice detection of the voltage peak may not be instantaneous. Nevertheless, the delay introduced by such detection may be ensured to match system operation frequency. That is, the delay introduced by the detection logic may be negligible relative to the switching frequency of the power amplifiers 20a, 20b.

Furthermore, in some cases a small delay between detection of the voltage peak and switching of the first/second power amplifier 20a, 20b may be desirable in order to avoid excitation of further resonant frequencies of the resonant tank. Thus, this delay may be implemented by a programmable element. The delay introduced by the detection logic may be negligible compared to the delay introduced by the programmable element or may be compensated by the programmable element.

The gate drive circuit 50 may switch off the second power amplifier 20b once a predetermined length of time has elapsed from switching on the second power amplifier 20b, and/or may switch off the first power amplifier 20a once a predetermined length of time has elapsed from switching on the first power amplifier 20a. This predetermined length of time may be based on the switching frequency. That is, the predetermined length of time may be configured to ensure that the switching occurs at the switching frequency. Accordingly, this predetermined length of time may be pre-programmed based on a desired switching frequency.

The gate drive circuit 50 may also be configured to switch on the second power amplifier 20b using the voltage at the first end of the primary winding 12. That is, the voltage on the drain of the first switch 22a may be used to drive (at least initially) the gate of the second switch 22b to turn on the second switch 22b. Equally, the gate drive circuit 50 may also be configured to switch on the first power amplifier 20a using the voltage at the second end of the primary winding 12. That is, the voltage on the drain of the second switch 22b may be used to drive (at least initially) the gate of the first switch 22a to turn on the first switch 22a. This therefore enables a self-sustained synchronized switching operation of the power amplifiers.

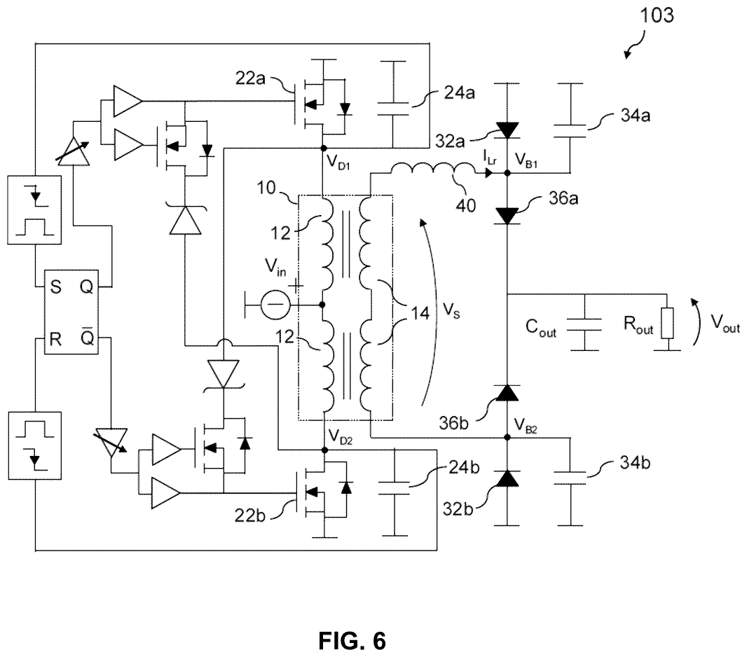

This self-sustained synchronized switching operation may be achieved using the circuit 103 as depicted in FIG. 6. This shows one implementation of the gate driver circuit integrated with the power converter 103. Of course, other implementations are possible, and any modifications would be readily apparent to the skilled person.

As shown, the SR latch defines the on state of the gate drive switches based on voltages VD1, VD2 on the first and second ends of the primary winding 12. When the voltage on the first side of the primary winding 12 peaks but then approach 0V, a pulse is generated to trigger the SR latch. The switching off command is fed back to the driver after a digital or analog programmable delay. The driver will switch off the first switch in a dissipative manner and use the connection to the voltage on the first end of the primary winding 12 through the diode to charge the gate of the second switch with energy recycling. Operation of the second switch is performed similarly.

More generally, the energy recycling may be achieved by using the charge that is present at the first side (or second side) of the primary winding 12 to turn on (e.g., charge a gate capacitance) the second switch 22b (or the first switch 22a). For this, a controllable current path may be provided between the first side of the primary winding 12 and the gate of the second switch 22b, and/or a controllable current path may be provided between the second end of the primary winding 12 and the gate of the first switch 22a. The respective controllable current path may include a diode and/or a switch (the switch may be referred to as “energy recycling switch”). In some implementations, the respective controllable current path may include a diode in series with the energy recycling switch. The energy recycling switch may be implemented as a transistor switch. In some implementations, the respective controllable current path may include a bidirectional blocking transistor switch, in which case the diode may be omitted. For example, the transistor switch may have a relatively low current capability (e.g., lower than a current capability of the first or second switch 22a, 22b). For example, the respective transistor switch may be controlled by a common control signal together with the first or second switch, as is indicated in FIG. 6. The energy recycling has the benefit that most of the charge that is required to turn on the first or second switch 22a, 22b is recycled in the power converter and is not simply dissipated. Therefore, the efficiency of the power converter can be increased. This may also allow to increase a power transfer to the secondary side, since reducing the losses for the operation of the primary side relieves the overall energy budget of the power converter. It may be the first switch 22a (or second switch 22b) is switched on by using the voltage that is present at the second side (or the first side) of the primary winding 12.

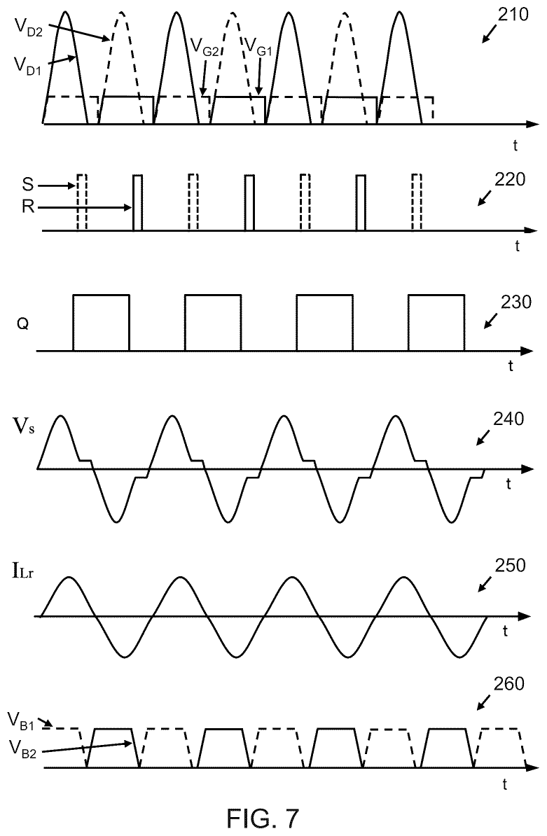

FIG. 7 presents various waveforms as the circuit depicted in FIG. 6 is operated. The waveforms are provided under the assumption that the switching frequency of the first and second power amplifiers 20a, 20b matches the resonant frequency of the secondary resonant tank.

Graph 210 shows the voltage, VD1, on the first end of the primary winding 12 and the voltage, VD2, on the second end of the primary winding 12, superimposed with the gate drive voltage, VG1, of the first switch 22a and the gate drive voltage, VG2, of the second switch 22b. Graph 220 shows the pulses, S and R, provided to the SR latch as a result of the detected end to the voltage peaks on the first end of the primary winding 12 and second end of the primary winding 12. Graph 230 shows the resultant output, Q, of the SR latch. Graph 240 shows the voltage, Vs, at the secondary winding 14. Graph 250 shows the current, ILr, through the tuning inductor 40, which is near-sinusoidal. Graph 260 shows the voltage, VB1, seen at the second rectifying device, and the voltage, VB2, seen at the fourth rectifying device. That is, VB1 is the voltage at the first end of the secondary winding 14, and VB2 is the voltage at the second end of the secondary winding 14.

As shown, the current flowing through the tuning inductor is nearly sinusoidal, and the voltage swing across the third and fourth capacitor causes the two rectifier devices to conduct. Under these resonance conditions, the output voltage Vout can exceed the peak-to-peak amplitude of the voltage reflected at the secondary winding 14, introducing thereby a further voltage boosting, if required.

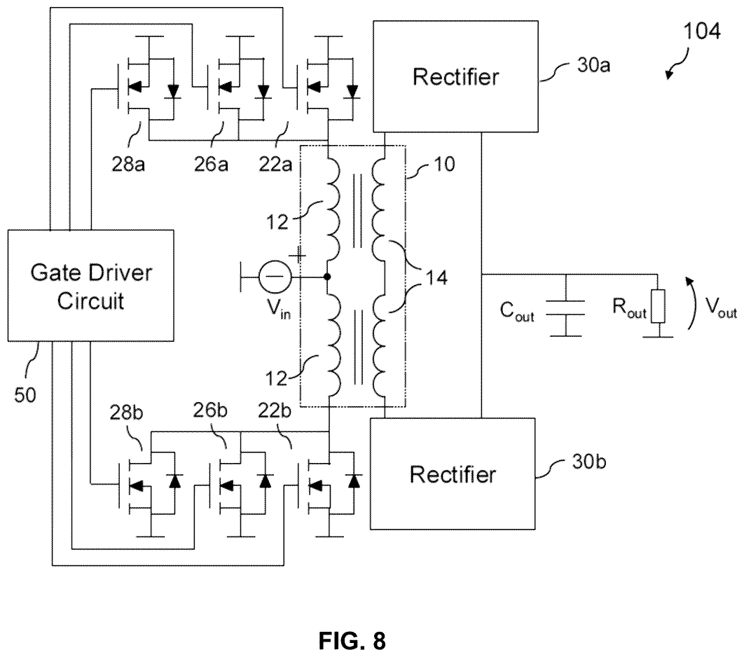

FIG. 8 presents another implementation of the circuit, in which both power amplifiers comprise three switches.

In contrast to circuits 101-103 of FIGS. 4-6, the first switch 22a and second switch 22b are each segmented into three different switches. Namely, the first power amplifier comprises first switch 22a, first auxiliary switch 26a, and first boost switch 28a. The second power amplifier comprises second switch 22b, second auxiliary switch 26b, and second boost switch 28a.

As shown, the first switch 22a, first auxiliary switch 26a, and first boost switch 28a may each be connected between the first side of the primary winding 12, and a reference potential. Equally, the second switch 22b, second auxiliary switch 26b, and second boost switch 28b may each be connected between the second side of the primary winding 12, and reference potential.

In some cases, the switches may have different current capabilities. For example, the first/second switch 22a/22b may have a first current capability, the first/second auxiliary switch 26a/26b may have a second current capability, and the first/second boost switch 28a/28b may have a third current capability. The first and second auxiliary switches 26a, 26b may have the lowest current capability. That is, the first and second auxiliary switches 26a, 26b may have the smallest active area. The first switch 22a, the second switch 22b, the first boost switch 28a, and the second boost switch 28b may each have a same current capability. In one example, the first auxiliary switch 26a may provide 10% of the total current capability of the first power amplifier, the first switch 22a may provide 45% of the total current capability of the first power amplifier, and the first boost switch 28a may provide 45% of the total capability of the first power amplifier. Likewise, the second auxiliary switch 26b may provide 10% of the total current capability of the second power amplifier, the second switch 22b may provide 45% of the total current capability of the second power amplifier, and the second boost switch 28b may provide 45% of the total capability of the second power amplifier. Nevertheless, implementations are not restricted hereto, and the switches may have different current relative current capabilities to this example (e.g., may all have the same current capability).

Each of the switches are controlled by a gate driver circuit 50. Each of the switches may be skewed in terms of turn-on time, to further increase the converter transferred power and efficiency. That is, differently than the previously described operation in which one power amplifier is turned on when the other is turned off, the switch, auxiliary switch and boost switch of each power amplifier may be turned on and/or off at different times.

For example, the switches of the first power amplifier may be controlled as follows:
(i) the first auxiliary switch 26a may be turned on responsive to the detection of the end of the resonant voltage peak on the first end of the primary winding 12. That is, the first auxiliary switch 26a may be turned on when the resonance voltage peak (detected at the same end of the primary winding 12 as the first power amplifier 20a) falls back down to close to 0V. The turn on energy for the first auxiliary switch 26a may be taken from an internal power supply;
(ii) the first auxiliary switch 26a may be turned off together with the first switch 22a (e.g., after a predetermined period of time from when the first switch 22a is turned on);
(iii) the first switch 22a is operated as previously described. Namely, the first switch 22a is turned on when a voltage peak is detected at the second end of the primary winding 12, and is turned off after a delay;
(iv) the first boost switch 28a may be operated with synchronized turn-on to the first switch 22a. That is, the first boost switch 28a may also turn on when a voltage peak is detected at the second end of the primary winding 12.
(v) the first boost switch 28a may be turned off responsive to the detection of the end of the resonant voltage peak on the second end of the primary winding 12. That is, the first boost switch 28a may be turned off when the resonance voltage peak (detected at the opposite end of the primary winding 12 as the first power amplifier 20a) falls back down to close to 0V. Thus, the operation of the boost switch 28a may be fully determined by the rising and falling of the voltage peak on the second side of the primary winding 12.

Of course, the second power amplifier 20b including the second switch 22b, second auxiliary switch 26b, and boost switch 28b may be controlled in a similar fashion.

This operation can ensure that the circuit doesn't lock onto higher resonant frequencies as previously discussed, whilst increasing the input to output transferred power and conversion efficiency.

It is further worth noting that, in some implementations, the boost switches may be removed. That is, the first power amplifier may comprise only the first switch and the first auxiliary switch, and/or the second power amplifier may comprise only the second switch and the second auxiliary switch. This may still provide an improvement in transferred power and conversion efficiency compared to power amplifiers comprising the first/second switch alone.

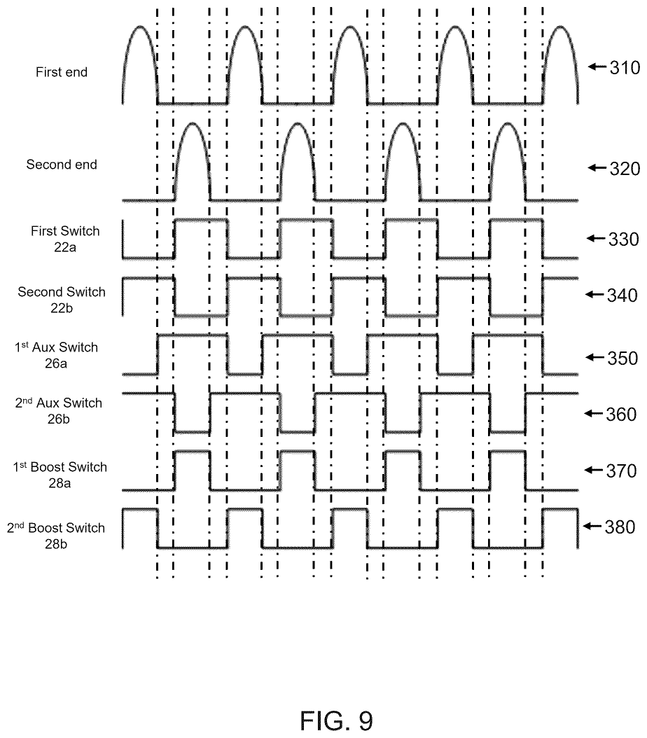

The operation of the power amplifiers of FIG. 8 is demonstrated by the timing diagrams of FIG. 9.

In particular, graph 310 shows the voltage on the first end of the primary winding (e.g., the drain of each of the first switch, the first auxiliary switch, and the first boost switch). Graph 320 shows the voltage on the second end of the primary winding (e.g., the drain of each of the second switch, the second auxiliary switch, and the second boost switch). As seen, the first end and the second end experience interleaved voltage peaks due to resonant response of the primary resonant tank.

Graph 330 shows the voltage applied to the gate of the first switch, and graph 340 shows the voltage applied to the gate of the second switch. The first switch thus turns on upon detection of the start of the voltage peak at the second end of the primary winding, and the second switch turns on upon detection of the start of the voltage peak at the first end of the primary winding. The first switch turns off after a predetermined time delay and the second switch turns off after the predetermined time delay. Due to the switch off a voltage peak at the opposite end of the primary winding to the switch is induced by excitation of the primary resonant tank.

Graph 350 shows the voltage applied to the gate of the first auxiliary switch, and graph 360 shows the voltage applied to the gate of the second auxiliary switch. The first auxiliary switch thus turns on when a voltage peak on the first end of the primary winding ends, and the second auxiliary switch turns on when a voltage peak on the second end of the primary winding ends. The first auxiliary switch turns off at the same time as the first switch and the second auxiliary switch turns off at the same time as the second switch (e.g., has a synchronized turn off with the first/second switch).

Finally, graph 370 shows the voltage applied to the gate of the first boost switch, and graph 380 shows the voltage applied to the gate of the second boost switch. As seen, the first boost switch turns on upon detection of the start of the voltage peak on the second end of the primary winding and turns off upon detection of the end of the voltage peak on the second end of the primary winding (e.g., is turned on only when a voltage peak is present on the second end of the primary winding). The second boost switch turns on upon detection of the start of the voltage peak on the first end of the primary winding and turns off upon detection of the end of the voltage peak on the first end of the primary winding (e.g., is turned on only when a voltage peak is present on the first end of the primary winding).

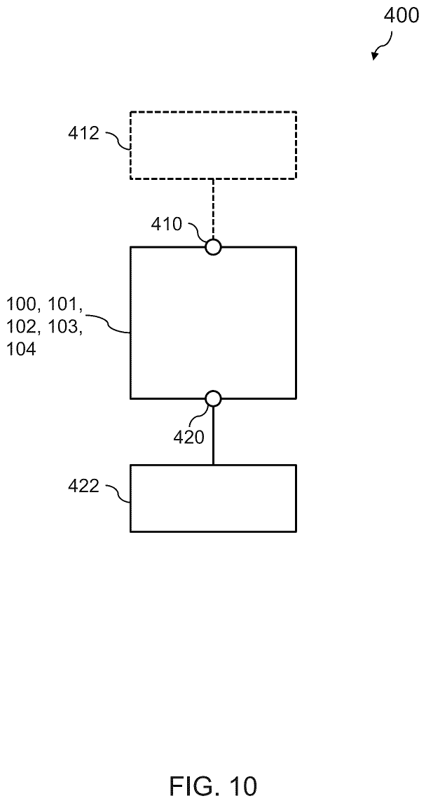

FIG. 10 depicts a system 300 incorporating one of the above-described isolated power converter circuits 100, 101, 102, 103, 104.

The system 400 comprises a first load terminal 410 that is configured for connection to a power source 412. The power source 412 may be provided or may be a separate component to the system 400. For example, the power source 412 may be any constant voltage power source. The first load terminal 410 is coupled to the source of the isolated power converter circuit. That is, the first load terminal 410 is electrically coupled to an intermediate tap of the primary winding 12 of the transformer 10.

Furthermore, the system comprises a second load terminal 420 connected to a load 422. The load 422 may be a gate driver for a power switch, a logic integrated circuit (IC), a sensor device, or a communication device, for example. The second load terminal 420 is coupled to the first rectifier and the second rectifier of the isolated power converter circuit. That is, the second load terminal 420 is electrically coupled an output of both the first rectifier and the second rectifier.

For example, the load may be a gate driver, and the gate driver and the isolated power converter circuit 100-104 may be arranged in a common package. The common package may provide external terminals (e.g., terminal 410 to receive power, and further terminals to receive and/or provide control signals, such as a drive output or a control signal input, or the like). In a further example, the system 400 may implement an integrated power module that integrates, in a common package, the isolated power converter circuit 100-104, at least one isolated gate driver that is being supplied with power by the isolated power converter 100-104, and at least one power transistor that is switched between switching states by the isolated gate driver.

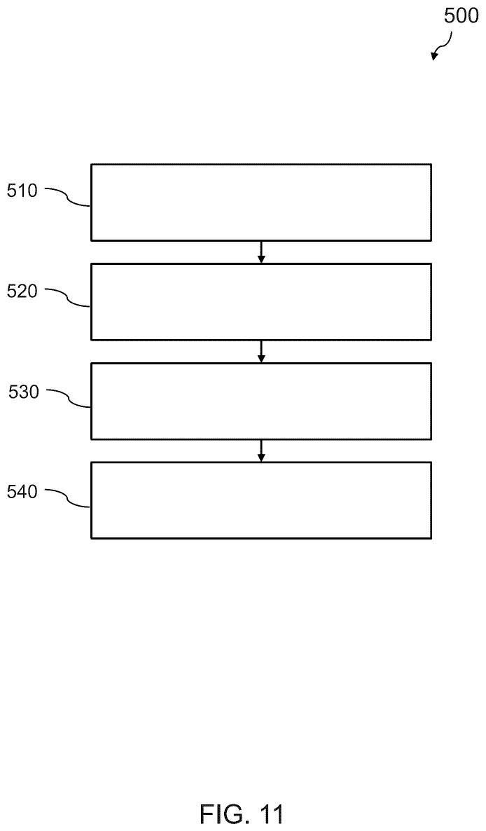

FIG. 11 presents a flow diagram of a method 500 for transferring power from a first side of an isolation transformer to a second side of the isolation transformer according to an implementation.

In step 510, power is provided to an intermediate tap of a primary winding on the first side of the isolation transformer. This power may be provided from a source. The intermediate tap may be a centre tap of the primary winding.

In step 520, a first resonance is generated in the primary winding using a first power amplifier coupled to a first end of the primary winding and a second power amplifier coupled to a second end of the primary winding.

That is, the first power amplifier and the second power amplifier may be controlled according to an interleaved mode of operation (where one amplifier is switched on, the other is switched off, and vice versa, at a switching frequency). If this switching frequency is near a resonant frequency of a primary resonant tank formed by the first power amplifier, second power amplifier and the primary winding (e.g., magnetising inductance of the transformer and leakage inductance of the primary winding), then a resonance may be generated.

In step 530, a current caused in a secondary winding on the second side of the isolation transformer that is inductively coupled to the primary winding is rectified using a first rectifier coupled to a first end of the secondary winding and a second rectifier coupled to a second end of the secondary winding. The current is induced due to the oscillating voltage on the primary winding, resulting in a current through the secondary winding. This current is then rectified using two rectifiers provided on opposing sides of the secondary winding.

In some cases, the oscillation of the current may be near the resonant frequency of a secondary resonant tank on the secondary side formed by the first rectifier, second rectifier and leakage inductance of the secondary winding. This may result in a further resonant voltage boost on the secondary side.

Finally, in step 540, the rectified current is provided to an output. The output may be connected to a load to be powered.

Although specific examples have been illustrated and described herein, it will be appreciated by those of ordinary skill in the art that a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

It should be noted that the methods and devices including its preferred implementations as outlined in the present document may be used stand-alone or in combination with the other methods and devices disclosed in this document. In addition, the features outlined in the context of a device are also applicable to a corresponding method, and vice versa. Furthermore, all aspects of the methods and devices outlined in the present document may be arbitrarily combined. In particular, the features of the claims may be combined with one another in an arbitrary manner.

It should be noted that the description and drawings merely illustrate the principles of the proposed methods and systems. Those skilled in the art will be able to implement various arrangements that, although not explicitly described or shown herein, embody the principles of the implementation and are included within its spirit and scope. Furthermore, all examples and implementations outlined in the present document are principally intended expressly to be only for explanatory purposes to help the reader in understanding the principles of the proposed methods and systems. Furthermore, all statements herein providing principles, aspects, and implementations of the implementation, as well as specific examples thereof, are intended to encompass equivalents thereof.

The following implementations are disclosed:
An isolated power converter circuit comprising: a transformer comprising a primary winding and a secondary winding, wherein an intermediate tap of the primary winding is coupled to a source; a first power amplifier coupled to a first end of the primary winding; a second power amplifier coupled to a second end of the primary winding; a first rectifier coupled to a first end of the secondary winding; and a second rectifier coupled to a second end of the secondary winding, wherein a capacitance provided at the first power amplifier and the second power amplifier, and an inductance provided by the transformer forms a primary resonant tank, and wherein a capacitance provided at the first rectifier and the second rectifier, and an inductance provided by the transformer forms a secondary resonant tank.
The circuit of implementation 1, wherein the first power amplifier comprises a first switch connected between the first end of the primary winding and a first reference potential, the second power amplifier comprises a second switch connected between the second end of the primary winding and a second reference potential, and a primary capacitor is provided between the first end of the primary winding and the second end of the primary winding, or a first capacitor is provided between the first end of the primary winding and the first reference potential, and a second capacitor is provided between the second end of the primary winding and the second reference potential.
The circuit of implementation 1 or 2, wherein the first rectifier comprises a first rectifying device connected between the first end of the secondary winding and a third reference potential, and a second rectifying device connected between the first end of the secondary winding and a load, the second rectifier comprises a third rectifying device connected between the second end of the secondary winding and a fourth reference potential, and a fourth rectifying device connected between the second end of the secondary winding and the load, and a secondary capacitor is provided between the first end of the secondary winding and the second end of the secondary winding, or a third capacitor is provided between the first end of the secondary winding and the third reference potential, and a fourth capacitor is provided between the second end of the secondary winding and the fourth reference potential.
The circuit of any of implementations 1-3, further comprising a gate drive circuit configured to control the first power amplifier and the second power amplifier in an interleaved mode of operation synchronized to a switching frequency.
The circuit of implementation 4, wherein the switching frequency is based on a resonant frequency of the primary resonant tank.
The circuit of implementation 5, wherein the switching frequency is smaller than or equal to the resonant frequency of the primary resonant tank.
The circuit of implementations 5 or 6, wherein a resonant frequency of the secondary resonant tank is configured based on the switching frequency.
The circuit of any of implementations 4-7, wherein the switching frequency is based on a resonant frequency of the secondary resonant tank.
The circuit of any of implementations 4-8, wherein the gate drive circuit is configured to: detect a voltage peak at the first end of the primary winding; and switch on the second power amplifier responsive to detecting the voltage peak.
The circuit of implementation 9, wherein the gate drive circuit is configured to: switch on the second power amplifier using the voltage at the first end of the primary winding.
The circuit of implementation 9 or 10, wherein the gate drive circuit is configured to: switch off the second power amplifier once a predetermined length of time has elapsed from switching on the second power amplifier, wherein the predetermined length of time is based on the switching frequency.
The circuit of implementation 9, wherein the second power amplifier comprises: a second switch connected between the second end of the primary winding and a second reference potential; a second auxiliary switch connected between the second end of the primary winding and the second reference potential; wherein the gate drive circuit is configured to: detect an end of a voltage peak at the second end of the primary winding; switch on the second auxiliary switch responsive to detecting the end of the voltage peak at the second end of the primary winding; and switch on the second switch responsive to detecting the voltage peak at the first end of the primary winding.
The circuit of implementation 12, wherein the gate drive circuit is further configured to switch off the second switch and the second auxiliary switch once a predetermined length of time has elapsed from switching on the second switch, wherein the predetermined length of time based on the switching frequency.
The circuit of implementation 12 or 13, wherein the second power amplifier further comprises: a second boost switch connected between the second end of the primary winding and the second reference potential, and wherein the gate drive circuit is further configured to: switch on the second boost switch responsive to detecting the voltage peak at the first end of the primary winding; detect an end of the voltage peak at the first end of the primary winding; and switch off the second boost switch responsive to detecting the end of the voltage peak at the first end of the primary winding.
The circuit of any one of implementations 4-14, wherein the gate drive circuit is configured to: detect a voltage peak at the second end of the primary winding; and switch on the first power amplifier responsive to detecting the voltage peak.
The circuit of implementation 15, wherein the gate drive circuit is configured to: switch on the first power amplifier using the voltage at the second end of the primary winding.
The circuit of implementation 15 or 16, wherein the gate drive circuit is configured to: switch off the first power amplifier once a predetermined length of time has elapsed from switching on the first power amplifier, wherein the predetermined length of time based on the switching frequency.
The circuit of implementation 15, wherein the first power amplifier comprises: a first switch connected between the first end of the primary winding and a first reference potential; a first auxiliary switch connected between the first end of the primary winding and the first reference potential; wherein the gate drive circuit is configured to: detect an end of a voltage peak at the first end of the primary winding; switch on the first auxiliary switch responsive to detecting the end of the voltage peak at the first end of the primary winding; and switch on the first switch responsive to detecting the voltage peak at the second end of the primary winding.
The circuit of implementation 18, wherein the gate drive circuit is further configured to switch off the first switch and the first auxiliary switch once a predetermined length of time has elapsed from switching on the first switch, wherein the predetermined length of time based on the switching frequency.
The circuit of implementation 18 or 19, wherein the first power amplifier further comprises: a first boost switch connected between the first end of the primary winding and the first reference potential, and wherein the gate drive circuit is further configured to: switch on the first boost switch responsive to detecting the voltage peak at the second end of the primary winding; detect an end of the voltage peak at the second end of the primary winding; and switch off the first boost switch responsive to detecting the end of the voltage peak at the second end of the primary winding.
The circuit any one of implementations 10-14 or 15-20, further comprising: a first controllable current path connecting the second power amplifier and the first end of the primary winding, and/or a second controllable current path connecting the first power amplifier and the second end of the primary winding, wherein the first/second controllable current path are configured to be switched between a current conducting state that allows charge to flow from the first/second end of the primary winding to the second/first power amplifier and a current blocking state, and the gate drive circuit is configured to control the first controllable current path and/or the second controllable current path.
The circuit of implementation 21, wherein the first controllable current path comprises a first energy recycling switch and/or the second controllable current path comprises a second energy recycling switch.
The circuit of implementation 22, wherein: the gate drive circuit is configured to switch on the first energy recycling switch when switching on the second power amplifier; and/or the gate drive circuit is configured to switch on the second energy recycling switch when switching on the first power amplifier.
The circuit of any one of implementations 1-23, wherein the transformer comprises a core including a material configured to provide galvanic isolation between the primary winding and the secondary winding.
The circuit of implementation 21, wherein the material has a relative magnetic permeability less than 10.
The circuit of any one of implementations 1-25, wherein the transformer comprises a core including a magnetic material.
The circuit of any one of implementations 1-26, further comprising a tuning inductor provided in series with the secondary winding, the tuning inductor forming part of the secondary resonant tank.
The circuit of any one of implementations 1-27, wherein the number of turns of the primary winding is the same as the number of turns of the secondary winding.

A system comprising: a first load terminal for connection to a power source; a second load terminal connected to a load; and an isolated power converter circuit according to any of implementations 1-28, wherein the first load terminal is coupled to the source of the isolated power converter circuit, and the second load terminal is coupled to the first rectifier and the second rectifier of the isolated power converter circuit.

A method for transferring power from a first side of an isolation transformer to a second side of the isolation transformer, the method comprising: providing power to an intermediate tap of a primary winding on the first side of the isolation transformer; generating a first resonance in the primary winding using a first power amplifier coupled to a first end of the primary winding and a second power amplifier coupled to a second end of the primary winding; rectifying a current caused in a secondary winding on the second side of the isolation transformer that is inductively coupled to the primary winding using a first rectifier coupled to a first end of the secondary winding and a second rectifier coupled to a second end of the secondary winding; and providing the rectified current to an output.

1. An isolated power converter circuit comprising:
a transformer comprising a primary winding and a secondary winding, wherein an intermediate tap of the primary winding is coupled to a source;
a first power amplifier coupled to a first end of the primary winding;
a second power amplifier coupled to a second end of the primary winding;
a first rectifier coupled to a first end of the secondary winding; and
a second rectifier coupled to a second end of the secondary winding,
wherein a capacitance provided at the first power amplifier and the second power amplifier, and an inductance provided by the transformer forms a primary resonant tank, and
wherein a capacitance provided at the first rectifier and the second rectifier, and an inductance provided by the transformer forms a secondary resonant tank.

2. The isolated power converter circuit of claim 1, wherein the first power amplifier comprises a first switch connected between the first end of the primary winding and a first reference potential,
the second power amplifier comprises a second switch connected between the second end of the primary winding and a second reference potential, and
a primary capacitor is provided between the first end of the primary winding and the second end of the primary winding, or a first capacitor is provided between the first end of the primary winding and the first reference potential, and a second capacitor is provided between the second end of the primary winding and the second reference potential.

3. The isolated power converter circuit of claim 1, wherein the first rectifier comprises a first rectifying device connected between the first end of the secondary winding and a third reference potential, and a second rectifying device connected between the first end of the secondary winding and a load,
the second rectifier comprises a third rectifying device connected between the second end of the secondary winding and a fourth reference potential, and a fourth rectifying device connected between the second end of the secondary winding and the load, and
a secondary capacitor is provided between the first end of the secondary winding and the second end of the secondary winding, or a third capacitor is provided between the first end of the secondary winding and the third reference potential, and a fourth capacitor is provided between the second end of the secondary winding and the fourth reference potential.

4. The isolated power converter circuit of claim 1, further comprising a gate drive circuit configured to control the first power amplifier and the second power amplifier in an interleaved mode of operation synchronized to a switching frequency.

5. The isolated power converter circuit of claim 4, wherein the switching frequency is based on a resonant frequency of the primary resonant tank and/or the switching frequency is based on a resonant frequency of the secondary resonant tank.

6. The isolated power converter circuit of claim 5, wherein a resonant frequency of the secondary resonant tank is configured based on the switching frequency.

7. The isolated power converter circuit of claim 4, wherein the gate drive circuit is configured to:
detect a voltage peak at the first end of the primary winding and
switch on the second power amplifier responsive to detecting the voltage peak; and/or
detect a voltage peak at the second end of the primary winding and
switch on the first power amplifier responsive to detecting the voltage peak.

8. The isolated power converter circuit of claim 7, wherein the gate drive circuit is configured to:
switch on the second power amplifier using a voltage at the first end of the primary winding, and/or
switch on the first power amplifier using a voltage at the second end of the primary winding.

9. The isolated power converter circuit of claim 8, further comprising:
a first controllable current path connecting the second power amplifier and the first end of the primary winding, and/or
a second controllable current path connecting the first power amplifier and the second end of the primary winding, wherein
the first controllable current path or the second controllable current path is configured to be switched between a current conducting state that allows charge to flow from the first end or the second end of the primary winding to the second power amplifier or the first power amplifier and a current blocking state, and
the gate drive circuit is configured to control the first controllable current path and/or the second controllable current path.

10. The isolated power converter circuit of claim 9, wherein the first controllable current path comprises a first energy recycling switch and/or the second controllable current path comprises a second energy recycling switch.

11. The isolated power converter circuit of claim 10, wherein:
the gate drive circuit is configured to switch on the first energy recycling switch when switching on the second power amplifier; and/or
the gate drive circuit is configured to switch on the second energy recycling switch when switching on the first power amplifier.

12. The isolated power converter circuit of claim 7, wherein the gate drive circuit is configured to:
switch off the second power amplifier once a predetermined length of time has elapsed from switching on the second power amplifier, and/or
switch off the first power amplifier once a predetermined length of time has elapsed from switching on the first power amplifier,
wherein the predetermined length of time is based on the switching frequency.

13. The isolated power converter circuit of claim 7, wherein the second power amplifier comprises:
a second switch connected between the second end of the primary winding and a second reference potential; and
a second auxiliary switch connected between the second end of the primary winding and the second reference potential,
wherein the gate drive circuit is configured to:
detect an end of a voltage peak at the second end of the primary winding;
switch on the second auxiliary switch responsive to detecting the end of the voltage peak at the second end of the primary winding; and
switch on the second switch responsive to detecting the voltage peak at the first end of the primary winding; or
wherein the first power amplifier comprises:
a first switch connected between the first end of the primary winding and a first reference potential; and
a first auxiliary switch connected between the first end of the primary winding and the first reference potential,
wherein the gate drive circuit is configured to:
detect an end of a voltage peak at the first end of the primary winding;
switch on the first auxiliary switch responsive to detecting the end of the voltage peak at the first end of the primary winding; and
switch on the first switch responsive to detecting the voltage peak at the second end of the primary winding.

14. The isolated power converter circuit of claim 13, wherein:
the gate drive circuit is further configured to switch off the second switch and the second auxiliary switch once a predetermined length of time has elapsed from switching on the second switch, wherein the predetermined length of time based on the switching frequency; and/or wherein:
the gate drive circuit is further configured to switch off the first switch and the first auxiliary switch once a predetermined length of time has elapsed from switching on the first switch, wherein the predetermined length of time based on the switching frequency.

15. The isolated power converter circuit of claim 13,
wherein the second power amplifier further comprises:
a second boost switch connected between the second end of the primary winding and the second reference potential,
wherein the gate drive circuit is further configured to:
switch on the second boost switch responsive to detecting the voltage peak at the first end of the primary winding;
detect an end of the voltage peak at the first end of the primary winding; and
switch off the second boost switch responsive to detecting the end of the voltage peak at the first end of the primary winding; or
wherein the first power amplifier further comprises:
a first boost switch connected between the first end of the primary winding and the first reference potential,
wherein the gate drive circuit is further configured to:
switch on the first boost switch responsive to detecting the voltage peak at the second end of the primary winding;
detect an end of the voltage peak at the second end of the primary winding; and
switch off the first boost switch responsive to detecting the end of the voltage peak at the second end of the primary winding.

16. A system comprising:
a first load terminal for connection to a power source;
a second load terminal connected to a load; and
an isolated power converter circuit comprising:
a transformer comprising a primary winding and a secondary winding, wherein an intermediate tap of the primary winding is coupled to a source;
a first power amplifier coupled to a first end of the primary winding;
a second power amplifier coupled to a second end of the primary winding;
a first rectifier coupled to a first end of the secondary winding; and
a second rectifier coupled to a second end of the secondary winding,
wherein a capacitance provided at the first power amplifier and the second power amplifier, and an inductance provided by the transformer forms a primary resonant tank,
wherein a capacitance provided at the first rectifier and the second rectifier, and an inductance provided by the transformer forms a secondary resonant tank, and
wherein the first load terminal is coupled to the source of the isolated power converter circuit, and the second load terminal is coupled to the first rectifier and the second rectifier of the isolated power converter circuit.

17. A method for transferring power from a first side of an isolation transformer to a second side of the isolation transformer, the method comprising:
providing power to an intermediate tap of a primary winding on the first side of the isolation transformer;
generating a first resonance in the primary winding using a first power amplifier coupled to a first end of the primary winding and a second power amplifier coupled to a second end of the primary winding;
rectifying a current caused in a secondary winding on the second side of the isolation transformer that is inductively coupled to the primary winding using a first rectifier coupled to a first end of the secondary winding and a second rectifier coupled to a second end of the secondary winding; and
providing the rectified current to an output.

18. The isolated power converter circuit of claim 8, further comprising:
a first controllable current path connecting the second power amplifier and the first end of the primary winding,
wherein the first controllable current path is configured to be switched between a current conducting state that allows charge to flow from the first end of the primary winding to the second power amplifier and a current blocking state, and
wherein the gate drive circuit is configured to control the first controllable current path.

19. The isolated power converter circuit of claim 8, further comprising:
a second controllable current path connecting the first power amplifier and the second end of the primary winding,
wherein the second controllable current path is configured to be switched between a current conducting state that allows charge to flow from the second end of the primary winding to the first power amplifier and a current blocking state, and
wherein the gate drive circuit is configured to control the second controllable current path.

20. The isolated power converter circuit of claim 8, further comprising:
a first controllable current path connecting the second power amplifier and the first end of the primary winding, and
a second controllable current path connecting the first power amplifier and the second end of the primary winding
the first controllable current path is configured to be switched between a current conducting state that allows charge to flow from the first end of the primary winding to the second power amplifier and a current blocking state,
wherein the second controllable current path is configured to be switched between a current conducting state that allows charge to flow from the second end of the primary winding to the first power amplifier and a current blocking state, and
wherein the gate drive circuit is configured to control the first controllable current path and the second controllable current path.
